(19) United States
(12) Patent Application Publication
(10) Pub. No.: US 2015/0109486 A1
(43) Pub. Date: Apr. 23, 2015

(54) FILTERING EXTRANEOUS IMAGE DATA IN CAMERA SYSTEMS

(71) Applicant: NVIDIA CORPORATION, Santa Clara, CA (US)

(72) Inventors: Muralidhara Ramalingaiah, Bangalore (IN); Manjunath Doddamadurai Nanjaiah, Bangalore (IN)

(73) Assignee: NVIDIA CORPORATION, Santa Clara, CA (US)

(21) Appl. No.: 14/056,215

(22) Filed: Oct. 17, 2013

(51) Int. Cl. H04N 5/359

(52) U.S. Cl. CPC H04N 5/359
USPC 348/241

(57) ABSTRACT

In one embodiment of the present invention a camera system includes a frame screener that configures an image signal processor (ISP) to ignore pixel data that does not contribute to image quality. For each image frame, the frame screener processes packets of pixel data. If the pixel data included in a particular packet is associated with an overflow state, then the frame screener determines whether the image frame should be discarded based on the number of processed pixels associated with the image frame and a minimum pixel threshold. If the frame screener determines that the image frame should be discarded, then the frame screener configures the ISP to bypass any memory and computational operations associated with the packet of pixel data. Advantageously, because the ISP disregards extraneous pixel data, the ISP may perform fewer operations and consume less power than an ISP included in a conventional camera system.

### BACKGROUND OF THE INVENTION

1. Field of the Invention

Embodiments of the present invention relate generally to image processing and, more specifically, to filtering extraneous image data in camera systems.

2. Description of the Related Art

A typical camera system includes a camera, a central processing unit (CPU), and an image signal processor (ISP). The specialized design of some ISPs allow these ISPs to perform certain image processing tasks much faster and using less power than a CPU. However, the specialized design of such ISPs also limits the types of tasks that these ISPs can perform. By contrast, the CPU is typically a more general-purpose processing unit and therefore can perform most tasks. Consequently, the CPU usually executes the overall structure of a software application and configures the ISP to covert pixel data received from the camera into a desired format. As part of the conversion, the ISP often performs real-time image enhancements, such as noise reduction, light balance, and edge enhancement.

Within the camera system, the camera and the ISP are typically connected to each other using a standardized camera serial interface (CSI), such as the Camera Serial Interface 3 (CSI-3). In operation, the camera sends pixel data associated with image frames to a camera host via the camera serial interface. The camera host controls the flow of the pixel data between the camera and the ISP. In particular, the camera host stores pixel data associated with image frames in an ISP memory that is coupled to the ISP. Subsequently, the ISP performs read operations on the ISP memory and post-processes the pixel data associated with each image frame.

Increasingly, the rate at which cameras sense input image data exceeds the ability of the cameras to process and transmit the data to the camera host via the camera serial interface. To address this issue, a typical camera implements a transmission buffer that stores pixel data to be transmitted via the camera serial interface. However, the size of the transmission buffer is limited, and the rate at which the camera produces pixel data may vary. If the camera receives input pixel data at an unexpectedly high rate, then the storage capacity of the transmission buffer is reached, and the camera is unable to store additional pixel data. In such a transmission overflow state, the camera discards subsequent pixel data until the transmission buffer is again available for data storage.

As part of the cameral serial interface protocol, the camera transmits overflow state information to the camera host. Subsequently, the camera host stores this overflow state information in the ISP memory in conjunction with any transmitted pixel data. The ISP then performs read operations on the ISP memory to access the pixel data associated with the image frame. If the amount of properly transmitted pixel data associated with the image frame is sufficient, then the ISP reconstructs the frame. By contrast, if the amount of properly transmitted pixel data associated with the image frame is too small for effective frame reconstruction, then the ISP discards all pixel data associated with the image frame.

Notably, if the ISP discards all pixel data associated with the image frame, then the memory read operations and the computational operations associated with determining whether to reconstruct the image frame do not contribute to the quality of the processed image data. Further, such unproductive operations reduce the performance of the ISP and unnecessarily increase power consumption. As is well known, any unnecessary computations and associated power consumption is generally undesirable, particularly for portable handheld devices where the processing capability and acceptable power consumption may be very limited.

Accordingly, what is needed in the art is a more effective approach to processing camera data.

### SUMMARY OF THE INVENTION

One embodiment of the present invention includes a system configured to filter pixel data. The system includes a camera, and a frame screener coupled to the camera and configured to process a first packet that includes first pixel data associated with a first image frame, determine that the first pixel data is associated with an overflow state, compute a total number of processed pixels represented by the first pixel data and any previously processed pixel data associated with the first image frame, determine that the total number of processed pixels is less than a minimum pixel threshold, and configure an image signal processor to bypass one or more memory or computational operations associated with the first pixel data.

One advantage of the disclosed techniques is that the camera system performs fewer irrelevant memory and computational operations compared to conventional camera systems. In particular, because the frame screener configures the ISP to disregard image frames for which the received data is too incomplete to permit effective frame reconstruction, the ISP processes less extraneous pixel data. Consequently, the throughput of the ISP is increased and the power consumption of the ISP is reduced compared to an ISP included in a conventional camera system.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a camera system configured to implement one or more aspects of the present invention;

FIG. 2 is a conceptually diagram illustrating how the camera system of FIG. 1 can be configured to process visual input data, according to one embodiment of the present invention;

FIG. 3 is a conceptual diagram illustrating how the frame screener of FIG. 1 may configure the image signal processor to process an image frame, according to one embodiment of the present invention;

FIG. 4 is a conceptual diagram illustrating how the frame screener of FIG. 1 may configure the image signal processor to disregard an image frame, according to one embodiment of the present invention; and

FIG. 5 is a flow diagram of method steps for configuring an image signal processor to process image frames, according to one embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

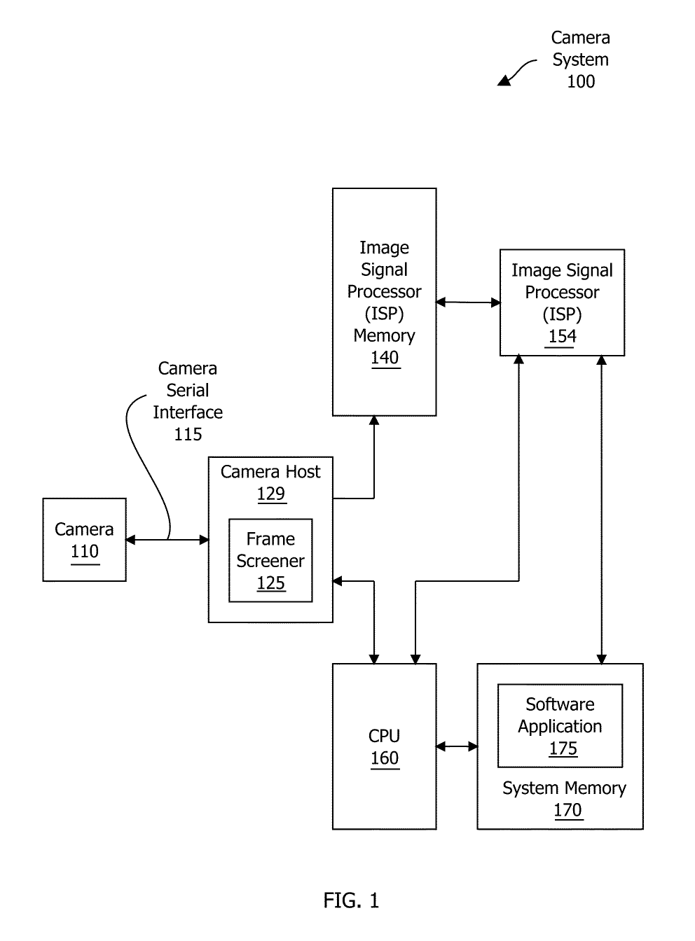

FIG. 1 is a block diagram illustrating a camera system 100 configured to implement one or more aspects of the present invention. As shown, the camera system 100 includes, without limitation, a camera 110 coupled to a camera host 129 via a camera serial interface 115. The camera host 129 is further coupled to a central processing unit (CPU) 160 and an image signal processor (ISP) memory 140 that is, in turn, coupled to an image signal processor (ISP) 154. In addition, both the CPU 160 and the ISP 154 are coupled to a system memory 170. The camera host 129, the camera serial interface 115, the CPU 160, the ISP memory 140, the ISP 154, and the system memory 170 may be implemented using one or more integrated circuit devices, such as programmable processors, application specific integrated circuits (ASICs), RF components, or memory devices, or in any other technically feasible fashion.

In operation, the camera 110 is configured to receive visual input information in the form of pixel data from input devices (not shown in FIG. 1), such a sensor, and transmit the information via the camera serial interface 115 to the camera host 129. The camera host 129 controls the flow of pixel data between the camera 110 and the ISP 154 via write operations to the ISP memory 140 and control signals to the CPU 160. The control signals work in conjunction with a software application 175 that resides in the system memory 170 and executes on the CPU 160 to control the operation of the ISP 154. Typically, for each image frame, the software application 175 configures the ISP 154 to perform read operations on the ISP memory 140 to access the pixel data associated with the image frame, process the pixel data, and convert the pixel data to a desired format. As part of the conversion, the software application 175 may configure the ISP 154 to perform real-time image enhancements, such as noise reduction, light balance, and edge enhancement. Further, the ISP 154 and other processors (not shown), such as a graphics processing unit (GPU), may work together to process and convert the pixel data.

As shown, the camera host 129 includes a frame screener 125. Advantageously, the frame screener 125 pre-processes the visual input data received by the camera host 129, identifying and exploiting opportunities to reduce the number of memory and computational operations that are performed by the ISP 154. In particular, if the visual input data received for an image frame is too incomplete for effective reconstruction, then the frame screener 125 causes the ISP 154 to disregard the image frame. By contrast, in conventional camera systems, the ISP 154 processes all image frames, performing read operations to access any pixel data associated with the image frame and performing computational operations to determine whether to reconstruct the image frame. In alternate embodiments, the frame screener 125 may be included in the camera 110 instead of the camera host 129. In other alternate embodiments, the frame screener 125 may be included in both the camera 110 and the camera host 129.

In various embodiments the camera 110 may be included in any type of input device, such as a smartphone or a video camera. Further, the camera system 100 may include any number and combination of cameras 110 that convey pixel data in any format. For example, the camera serial interface 115 may implement any serial communication protocol, such as CSI-2 or UniPort-M. In some embodiments, the ISP 154 may be integrated with one or more other the other elements of FIG. 1 to form a single system. For example, the ISP 154 may be integrated with CPU 160, the camera host 129, and other connection circuitry on a single chip to form a system on chip (SoC).

It will be appreciated that the system shown herein is illustrative and that variations and modifications are possible. As a general matter, the camera system 100 may include any number of processors and implement any connection topology. For example, the camera system 100 may include any number, including zero, and combination of CPUs 160, ISPs 154, GPUs, video decode processors, video encode processors, audio processors, etc. Further, the camera system 100 may provide any type of storage for application and data, including on-chip memory, fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, communication paths within the camera system 100 may be implemented using any technically suitable protocols, including, without limitation, AGP (Accelerated Graphics Port), HyperTransport, or any other bus or point-to-point communication protocol known in the art. Lastly, in certain embodiments, one or more components shown in FIG. 1 may not be present. For example, the system memory 170 and the ISP memory 140 could be consolidated into a single memory.

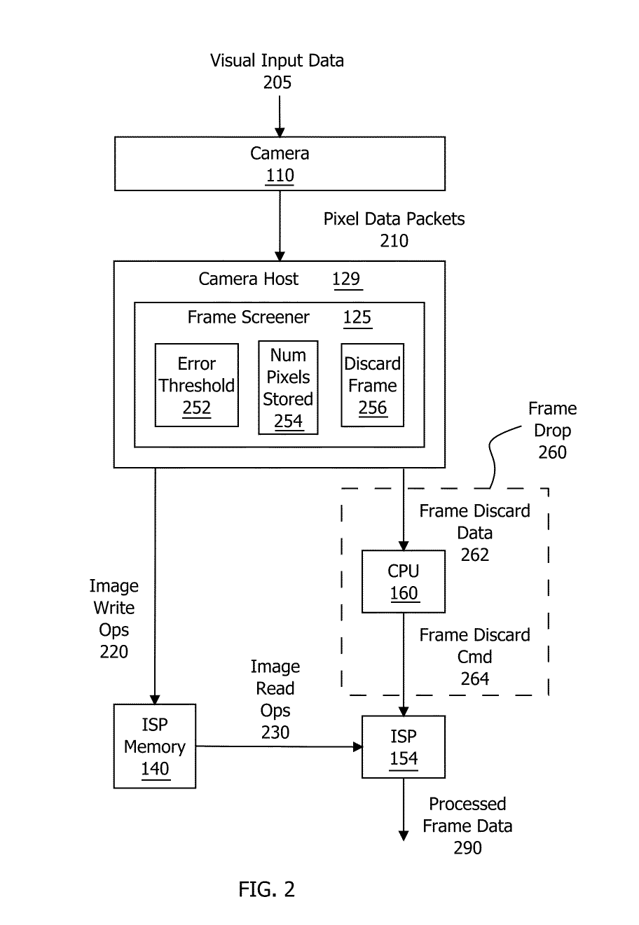

FIG. 2 is a conceptually diagram illustrating how the camera system 100 of FIG. 1 can be configured to process visual input data 205, according to one embodiment of the present invention. The visual input data 205 conveys a succession of image frames (i.e. collection of pixels) representing a succession of images. Together, the camera 110, the camera host 129 and the CPU 160 control the processing of the image frames by the ISP 154.

For each image frame, the camera 110 processes the visual input data 205 and transmits the data to the camera host 129 as pixel data packets 210. As previously disclosed, the camera 110 and the camera host 129 are coupled via the camera serial interface 115 of FIG. 210. In particular, the camera serial interface 115 is compliant with a CSI-3 specification, and the pixel data packets 210 may be encoded in any image or video format that is supported by the CSI-3 interface. In the CSI-3 interface, various bits included in the header of each pixel data packet 210 indicate characteristics of the pixel data packet 210. In one embodiment of the camera system 100, a bit included in the pixel data packets 210 indicates that each complete pixel data packet 210 correspond to a different image frame. In particular, the camera 110 nominally transmits the visual input data 205 corresponding to an image frame as a single pixel data packet 210. After transmitting the pixel data packet 210 corresponding to an image frame, the camera 110 transmits an end of payload (EOP) packet that indicates that the camera 110 has completed the transmission of the pixel data packets 210 that are associated with the image frame.

In operation, the rate at which the camera 110 receives the visual input data 205 may exceed the ability of the camera 110 to process and transmit a complete image frame to the camera host 129. To partially address this issue, the camera 110 implements a transmission buffer that stores pixel data to be transmitted via the camera serial interface 115. However, the size of the transmission buffer is limited, and the rate at which the camera 110 receives the visual input data 205 may vary. Further, in alternate embodiments, the camera 110 may not implement a transmission buffer. If the camera 110 is unable to process and transmit all of the visual input data 205 associated with a current image frame, then the camera 110 ceases transmission of the current pixel data packet 210. If the camera 110 recovers from the overflow state while processing the current image frame, then the camera 110 transmits a continuing pixel data packet 210. If the camera 110 is unable to resume transmission during the current image frame, then the camera 110 does not transmit any more “valid” pixel data associated with the image frame. After transmitting the valid pixel data associated with the image frame, the camera 110 transmits an EOP that includes a bit that specifies an overflow state. This EOP indicates both that the camera 110 has transmitted incomplete data associated with the current image frame and that the camera 110 has completed the pixel data transmission associated with the current image frame.

In a conventional camera system, upon receiving the pixel data packets associated with an image frame, the camera host converts the pixel data packets into image data, and performs image write operations to the ISP memory. Subsequently, the CPU configures the ISP to perform image read operations to access the image data and then perform image processing operations. In particular, if the image frame is associated with incomplete image data, then the ISP may determine to reconstruct or discard the image frame.

Advantageously, to reduce the number of useless operations associated with image frames that are too incomplete for effective reconstruction, the frame screener 125 configures the ISP 154 to ignore such image frames. To enable the frame screener 125 to flexibly and effective determine whether a particular image frame is unsalvageable, the frame screener 125 includes an error threshold 252, a number (num) pixels stored 254 and a discard frame 256.

The error threshold 252 specifies the maximum number of “invalid” pixels (i.e., pixels for which data is not received by the camera host 129) that may be included in a meaningful image frame. If the error threshold 252 is exceeded, then the image frame is considered too incomplete for effective reconstruction. The error threshold 252 may be set and implemented in any technically feasible fashion. For instance, the software application 175 may set the error threshold 252 based on image quality requirements. In some embodiments, the error threshold 252 may represent the minimum number of valid pixels required for effective reconstruction of an image frame.

The number pixels stored 254 indicates the number of pixels included in the current image frame for which the camera host 129 has performed image write operations 220 to store the associated pixel data in the ISP memory 140. Notably, the camera host 129 may perform image write operations 220 associated with certain pixels included in the current image frame while receiving the data associated with other pixels included in the current image frame. In operation, when the camera host 129 receives the first pixel data packet 210 associated with a particular image frame, the camera host 129 determines a base memory address associated with the image frame and the ISP memory 140. In addition, the frame screener 125 sets the number pixels stored 254 to zero. As the camera host 129 performs the image write operation 220 associated with a particular pixel, the frame screener 125 increments the number pixels stored 254. In this fashion, the frame screener 125 tracks the number of pixels included in the current image frame for which the ISP memory 140 includes data. The frame screener may implement the number pixels stored 254 in any technically feasible fashion. For instance, the frame screener 125 may include a counter that tracks the number pixels stored 254.

The discard frame 256 field indicates whether the current image frame is to be dropped without processing by the ISP 154. Initially, the frame screener 125 sets the discard frame 256 to a value of false to indicate that the image frame is considered to be “complete.” Subsequently, if the frame screener 125 determines that the image frame is too incomplete to enable the ISP 154 to produce effective processed frame data 290, then the frame screener 125 sets the discard frame 256 to true.

In operation, if the pixel data packets 210 indicate that the current image frame is associated with an overflow state, then the frame screener 125 determines the number of pixels included in the current image frame that are represented by the data included in the pixel data packets 210. The frame screener 125 may determine this number of “valid” pixels in any technically feasible. For instance, the frame screener 125 may access fields included in the pixel data packets 210 that specify the position of the represented pixels, such as an X coordinate, a Y coordinate, and an offset field. After determining the number of valid pixels, the frame screener 125 determines whether the difference between the number of pixels included in each image frame and the number of valid pixels exceeds the error threshold 252. If this difference exceeds the error threshold 252, then the frame screener 125 sets the discard frame 256 to true and the camera host 129 no longer processes pixel data packets 210 corresponding to the current image. In particular, the camera host 129 discards all remaining pixel data included in the pixel data packets 210 without performing additional, unnecessary, image write operations 220 to the ISP memory 140.

Advantageously, if the frame screener 125 sets the discard frame 256 to true, then the frame screener 125 causes the ISP 154 to disregard the current image frame without performing any image read operations 230 to access data associated with the current image frame data. Further, because the ISP 154 does not access any data associated with the current image frame, the ISP 154 does not perform any computational operations to determine whether to drop the current image frame. Consequently, the camera system 100 performs more efficiently and consumes less power than conventional camera systems.

As shown, the frame screener 125 coordinates a frame drop 260 by sending frame discard data 262 to the CPU 160. The frame discard data 262 includes the number pixels stored 254 and the base memory address specifying the location in the ISP memory 140 to which the camera host 129 commenced writing data associated with the current image frame. The CPU 160 then configures the ISP 154 via one or more frame discard commands (cmd) 264. The frame discard commands 264 cause the ISP 154 to bypass the image read operations 230 associated with the current image frame, thereby effectively bypassing the current image frame.

For example, suppose that the camera host 129 were configured to store the pixels associated with sequential image frames by linear order in the ISP memory 140. In such a scenario, the CPU 160 would perform an addition operation on the current image base memory address and the offset corresponding to the number pixel stored 254 to generate a subsequent image frame base memory address. The CPU 160 would then generate frame discard commands 264 that would cause the ISP 154 to perform image read operations 230 for the image frame starting at the subsequent image frame base memory address instead of the current image base memory address. Advantageously, in such a scenario, the ISP 154 would sequentially process the complete image frame immediately preceding the current image frame and the complete image frame immediately following the complete image frame, without processing the current image frame.

In alternate embodiments, the frame screener 125 may configure the ISP 154 to ignore the current image frame in any technically feasible fashion. In some embodiments, the frame screener 125 may orchestrate the frame drop 260 independently of the CPU 160. For instance, the camera host 129 may be configured to cease performing image write operations 220 associated with the current image frame and to set the base memory address of the subsequent image frame to match the base memory address of the current image frame. In this fashion, the camera host 129 overwrites the pixel data included in the ISP memory 140 that is associated with the current image frame, and the ISP 154 will not be perturbed by any data associated with the current image frame. In such an embodiment, the frame screener 125 may not include the number pixels stored 254 field.

If the frame screener 125 determines that an incomplete image frame is salvageable or the pixel data packets 210 indicate that the current image frame is not associated with an overflow state, then the frame screener 125 sets the discard frame 256 to false. In such a scenario, the camera host 129 processes the image frame in the conventional manner, generating the processed frame data 290.

In alternate embodiments, a bit included in the headers of the pixel data packets 210 indicates that each pixel data packet 210 corresponds to a separate image line in an image frame. In such embodiments, if the visual input data 205 corresponds to an image frame that includes N image lines, then the camera 110 typically transmits the visual input data 205 as N separate pixel data packets 210—one corresponding to each of the N image lines. After transmitting the N pixel data packets 210 corresponding to an image frame, the camera 110 transmits an EOP packet that indicates that no more data will be transmitted for the current image frame. The EOP packet encodes the status of the previous pixel data packet 210—indicating whether the pixel data packet 210 includes complete information for the corresponding image line. Further, each pixel data packet 210 includes a bit that indicates whether the previous pixel data packet 210 includes complete information for the previous image line. For example, an overflow state of the pixel data packet 210 representing the image line 5 is reflected in a bit included in the header of the pixel data packet 210 representing the image line 6.

In embodiments in which each pixel data packet 210 corresponds to a separate image line in an image frame, the operation of the frame screener 125 is modified accordingly. For instance, the frame screener 125 may determine that the number of “invalid” pixels included in the initial N lines of a current image frame exceed the error threshold 252. In such a scenario, the camera host 129 ceases processing the pixel data packets 210 associated with subsequent lines in the current image frame and configures the ISP 154 to ignore all previous lines in the current image frame.

In yet other embodiments where each pixel data packet 210 corresponds to a separate image line in an image frame, the frame screener 125 is included in the camera 110 instead of the camera host 129. In such embodiments, the camera 110 tracks the number of transmitted pixels and determines whether the error threshold 252 is exceeded. If the camera 110 determines that the error threshold 252 is exceeded, then the camera 110 does not transmit any subsequent data associated with the image frame. In particular, the camera 110 does not transmit any additional pixel data packets 210 associated with subsequent image lines included in the image frame. Instead, the camera 110 transmits the EOP packet indicating that the image frame is associated with an overflow state.

As persons skilled in the art will recognize, embodiments of the current invention include any techniques that identify and discard extraneous image frame data without permitting the ISP 154 to perform operations on the extraneous image frame data.

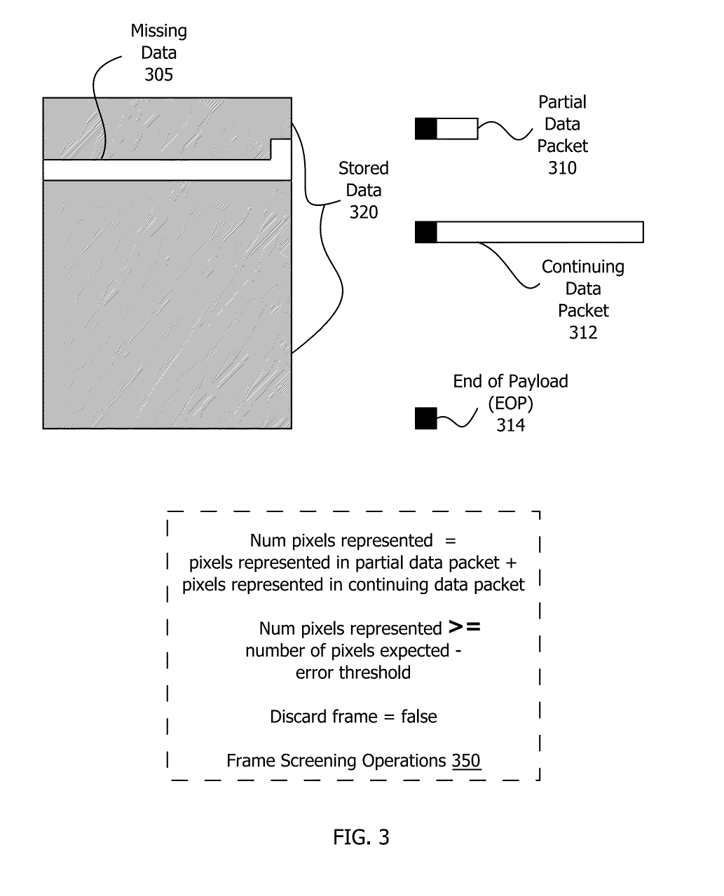

FIG. 3 is a conceptual diagram illustrating how the frame screener 125 of FIG. 1 may configure the image signal processor (ISP) 154 to process an image frame, according to one embodiment of the present invention. For explanatory purposes, the context of FIG. 3 is that the camera 110 is transmitting an image frame to the camera host 129 and experiences an overflow.

Since the camera 110 experiences a data overflow, the image frame includes pixels that correspond to missing data 305. These pixels are represented in FIG. 3 as unfilled portions of the image frame. The image frame also includes pixels that correspond to data that is transmitted as the pixel data packets 210, and these pixels are represented as filled portions of the image frame. Each pixel data packet 210 includes header information that is depicted as a filled portion of the pixel data packet 210 and data that is depicted as unfilled portions of the pixel data packets 210. Notably, the camera 110 is configured to nominally transmit a single pixel data packet 210 for each complete image frame. However, after transmitting a partial data packet 310, the camera 110 experiences an overflow.

In operation, upon receiving the header of the partial data packet 310, the camera host 129 sets a base memory address to represent the location in the ISP memory 140 associated with the image frame. Further, the frame screener 125 sets the number pixels stored 254 to zero and the discard frame 256 to false. As the camera host 129 receives the data included in the partial data packet 310, the camera host 129 performs the image write operations 220 to store the data in the ISP memory 140 as stored data 320. The frame screener 125 increments the number pixels stored 254 accordingly.

The camera 110 then experiences an overflow and terminates the partial data packet 310. The camera 110 is unable to successfully transmit the missing data 305, but is able to recover from the overflow and transmits a continuing data packet 312. The camera host 129 receives the data included in the continuing data packet 312 and performs the image write operations 220 to store the data in the ISP memory 140 as additional stored data 320. The frame screener 125 continues to increment the number pixels stored 254 accordingly. After the camera 110 finishes transmitting data associated with the image frame, the camera 110 transmits an end of payload (EOP) 314 that indicates both that an overflow occurred and that the camera 110 has finished transmitting data associated with the image frame.

After receiving the end of payload 314, the frame screener 125 performs frame screening operations 350. Together, the header information in the partial data packet 310, the header information in the continuing data packet 312, and the header information in the EOP 314 enable the frame screener 125 to determine the total number of pixels for which the camera host 129 received data. In operation, the frame screener 125 performs an addition operation between the number of pixels represented in the partial data packet 310 and the number of pixels represented in the continuing data packet 312 to determine the total number of pixels represented in the pixel data packets 210. The frame screener 125 then performs a subtraction operation between the number of pixels included in a complete image frame and the error threshold 252 to determine a minimum number of “valid” pixels. As persons skilled in the art will recognize, the frame screener 125 may perform a calculation to determine the minimum number of valid pixels once, store the result, and apply the result to multiple image frames. Alternatively, the software application 175 may configure the frame screener 125 to implement a minimum number of valid pixels instead of the error threshold 252.

The frame screener 125 then performs a comparison operation between the minimum number of “valid” pixels and the total number of pixels represented in the pixel data packets 210. As shown, the missing data 305 is a relatively small portion of the image frame. In particular, the total number of pixels represented in the pixel data packets 210 exceeds the minimum number of “valid” pixels, and the frame screener 125 determines that the final value of the discard frame 256 for the image frame is false.

The frame screener 125 may perform the frame screening operations 350 in any technically feasible fashion and at any appropriate point in time. In some embodiments, the frame screener 125 may perform the frame screener operations 350 upon receiving the header information in the continuing data packet 312. In such embodiments, the frame screener 125 may compare the number of pixels represented by the missing data 305 to the error threshold 252 to determine that the value of the discard frame 256 for the image frame is false.

Because the frame screener 125 determines that the value of the discard frame 256 for the image frame is false, the camera host 129 and the CPU 160 allow the ISP 154 to process the image frame in the conventional manner. More specifically, as shown in FIG. 2, the ISP 154 performs the image read operations 230, reconstructs the image frame, and generates the processed frame data 290.

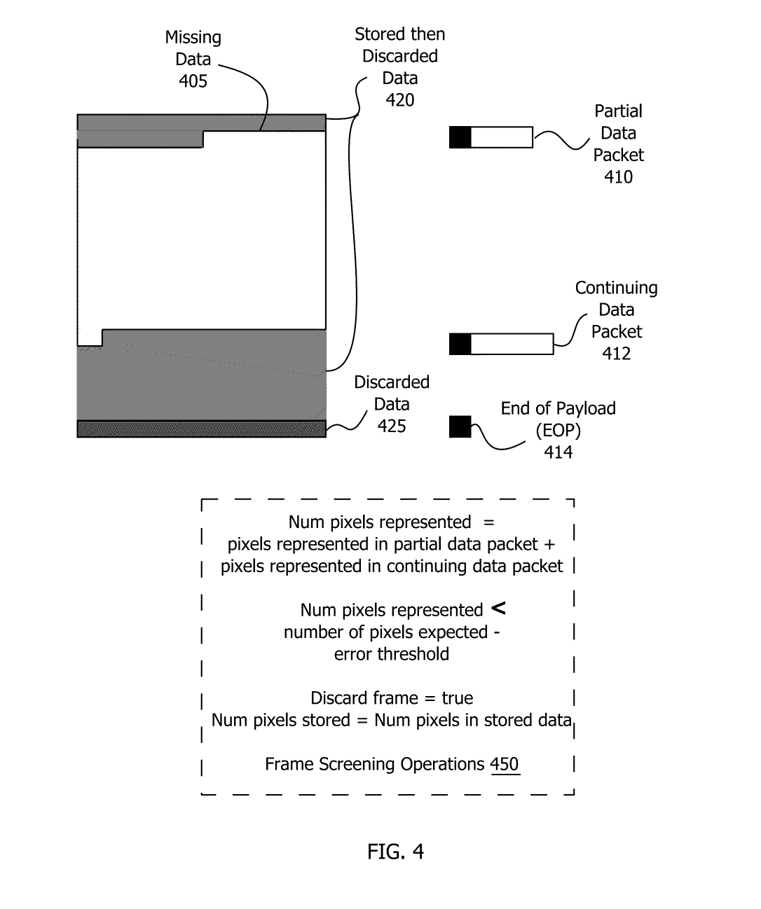

FIG. 4 is a conceptual diagram illustrating how the frame screener 125 of FIG. 1 may configure the image signal processor (ISP) 154 to disregard an image frame, according to one embodiment of the present invention. For explanatory purposes, the context of FIG. 4 is that the camera 110 is transmitting an image frame to the camera host 129 and experiences an overflow.

Since the camera 110 experiences a data overflow, the image frame includes pixels that correspond to missing data 405. These pixels are represented in FIG. 4 as unfilled portions of the image frame. The image frame also includes pixels that correspond to data that is transmitted as the pixel data packets 210. These pixels are represented in FIG. 4 as filled portions of the image frame. Each pixel data packet 210 includes header information that is depicted as a filled portion of the pixel data packet 210 and data that is depicted as unfilled portions of the pixel data packets 210. Notably, the camera 110 is configured to nominally transmit a single pixel data packet 210 for each complete image frame. However, after transmitting a partial data packet 410, the camera 110 experiences an overflow.

In operation, upon receiving the header of the partial data packet 410, the camera host 129 sets a base memory address to represent the location in the ISP memory 140 associated with the image frame. Further, the frame screener 125 sets the number pixels stored 254 to zero and the discard frame 256 to false. As the camera host 129 receives the data included in the partial data packet 410, the camera host 129 performs the image write operations 220 to store the data in the ISP memory 140 as stored then discarded data 420. The frame screener 125 increments the number pixels stored 254 accordingly. In operation, the camera host 129 may schedule and perform the image write operations 220 in any technically feasible fashion. For instance, the camera host 129 may perform the image write operations 220 per line, per block, or per memory page.

The camera 110 then experiences an overflow and terminates the partial data packet 410. The camera 110 is unable to successfully transmit the missing data 405, but is able to recover from the overflow and transmits a continuing data packet 412. The camera host 129 receives the data included in the continuing data packet 412 and performs the image write operations 220 to store the data in the ISP memory 140 as additional stored then discarded data 420. The frame screener 125 continues to increment the number pixels stored 254 accordingly. After the camera 110 finishes transmitting data associated with the image frame, the camera 110 transmits an end of payload (EOP) 414 that indicates both that an overflow occurred and that the camera 110 has finished transmitting data associated with the image frame. Notably, the camera 110 transmits the EOP 414 before the camera host 129 completely stores the data included in the continuing data packet 412 in the ISP memory 140. In alternate embodiments, the camera host 129 may completely store the data included in the continuing data packet 412 in the ISP memory 140 before the camera 110 transmits the EOP 414.

After receiving the end of payload 414, the frame screener 125 performs frame screening operations 450. Together, the header information in the partial data packet 410, the header information in the continuing data packet 412, and the header information in the EOP 414 enable the frame screener 125 to determine the total number of pixels for which the camera host 129 received data. In operation, the frame screener 125 performs an addition operation between the number of pixels represented in the partial data packet 410 and the number of pixels represented in the continuing data packet 412 to determine the total number of pixels represented in the pixel data packets 210. The frame screener 125 then performs a subtraction operation between the number of pixels included in a complete image frame and the error threshold 252 to determine a minimum number of “valid” pixels. As persons skilled in the art will recognize, the frame screener 125 may perform a calculation to determine the minimum number of valid pixels once, store the result, and apply the result to multiple image frames. Alternatively, the software application 175 may configure the frame screener 125 to implement a minimum number of valid pixels instead of the error threshold 252.

The frame screener 125 then performs a comparison operation between the minimum number of valid pixels and the total number of pixels represented in the pixel data packets 210. As shown, the missing data 405 is a relatively large portion of the image frame. In particular, the total number of pixels represented in the pixel data packets 210 is less than the minimum number of valid pixels. Consequently, the frame screener 125 determines that the final value of the discard frame 256 for the image frame is true. Upon determining that the final value of the discard frame 256 is true, the frame screener 125 causes the camera host 129 to cease performing the image read operations 220 associated with the pixel data packets 210. Thus, as shown, the camera host 129 does not perform any image read operations 220 to store discarded data 425.

The frame screener 125 may perform the frame screening operations 450 in any technically feasible fashion and at any appropriate point in time. In some embodiments, the frame screener 125 may perform the frame screener operations 450 upon receiving the header information in the continuing data packet 412. In such embodiments, the frame screener 125 may compare the number of pixels represented by the missing data 405 to the error threshold 252 to determine that the value of the discard frame 256 for the image frame is true.

Because the frame screener 125 determines that the value of the discard frame 256 for the image frame is true, the frame screener 450 collaborates with the CPU 160 to ensure that the ISP 154 does not perform any operations associated with the image frame. More specifically, as shown in FIG. 2, the frame screener 125 sends the frame discard data 262 to the CPU 160. The frame discard data 262 includes the number pixels stored 254 and the base memory address of the stored then discarded data 420. The CPU 160 then configures the ISP 154 via one or more frame discard commands 264. The frame discard commands 264 cause the ISP 154 to bypass the image read operations 230 associated with the image frame, thereby effectively bypassing the current image frame. More specifically, the CPU 160 generates frame discard commands 264 that cause the ISP 154 to perform image read operations 154 starting at the end of the stored then discarded data 420 instead of the beginning of the stored then discarded data 420.

By contrast, in a conventional camera system, the camera host performs image write operations to store all of the data included in the pixel data packets in the ISP memory. Further, the ISP performs image read operations to access this information and computational operations to determine whether to discard the image frame. Consequently, the camera system 100 performs less unnecessary operations associated with irrelevant image frames than conventional camera systems. Advantageously, by reducing the number of operation performed by the ISP 154, the frame screener 125 increases the efficiency and decreases the power consumption of the ISP 154 and, therefore, the computer system 100.

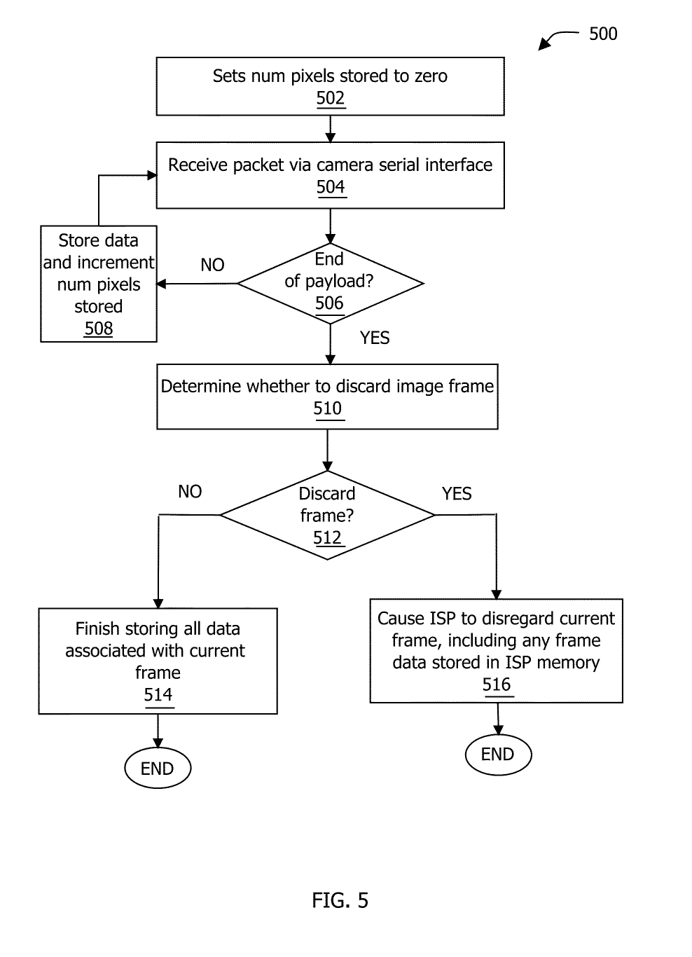

FIG. 5 is a flow diagram of method steps for configuring an image signal processor to process image frames, according to one embodiment of the present invention. Although the method steps are described with reference to the systems of FIGS. 1-4, persons skilled in the art will understand that any system configured to implement the method steps, in any order, falls within the scope of the present invention. For explanatory purposes, the description of FIG. 5 assumes that the camera host 129 is receiving an image frame from the camera 110 via the camera serial interface 115 and that there is a single data packet associated with each complete image frame.

As shown, a method 500 begins at step 502, where the frame screener 125 included in the camera host 129 sets the number pixels stored 254 to zero. At step 504, the camera host 129 receives a packet that is associated with the image frame via the camera serial interface 115. At step 506, the camera host 129 determines whether the packet is an end of payload (EOP) packet. If, at step 506, the camera host 129 determines that the packet is not an end of payload packet, then the method 500 proceeds to step 508. At step 508, the camera host 129 performs image write operations 220 to store the pixel data included in the packet in the ISP memory 140. As previously disclosed herein, the camera host 129 may perform and schedule the image write operations 220 in any technically feasible manner. As part of step 508, the frame screener 125 increments the number pixel stored 254 to correspond to the number of pixels in the image frame for which the camera host 129 has stored data in the ISP memory 140. The method 500 then returns to step 504. The camera host 129 cycles through steps 504-508, receiving and processing packets via the camera serial interface 115 until the camera host 129 receives an end of payload packet. In alternate embodiments, the end of payload packet may be omitted, and the camera host 129 detects the end of the image frame based on receiving a header packet for the next image frame. In such embodiments, the header packet for the next image frame encodes whether an overflow is associated with the image frame.

Referring back now to step 506, if the camera host 129 determines that the packet is an end of payload packet, then the method 500 proceeds to step 510. At step 510, the frame screener 126 determines whether to discard the image frame. Notably, if the end of payload packet indicates that there is no overflow associated with the image frame, then the frame screener 126 determines that the image frame is “complete,” and the frame screener 126 determines not to discard the image frame. However, if the end of payload packet indicates that there is an overflow associated with the image frame, then the frame screener 126 evaluates the number of pixels represented in the data received in conjunction with the pre-configured error threshold 252 to determine whether to discard the image frame. The frame screener 125 may perform this evaluation in any technically feasible fashion. For instance, the frame screener 125 may compare the number of pixels included in a complete image frame to the number of pixels received via the camera serial interface 115. In alternate embodiments, the frame screener 125 may compare the number of pixels for which data is not received in conjunction with the pre-configured error threshold 252. At part of step 510, the frame screener 125 sets the value of the discard frame 256 to reflect whether the image frame is to be disregarded by the ISP 154.

At step 512, if the value of the discard frame 256 is false (indicating that the image frame is to be processed by the ISP154), then the method 500 proceeds to step 514. At step 514, the camera host 129 finishes any incomplete image write operations 220—ensuring that all of the data received via the camera serial interface 115 is stored in the ISP memory 140. Notably, because the value of the discard frame 256 is false and the camera host 129 completes the image write operations 220 associated with the image frame, the ISP154 processes the image frame in the conventional manner. More specifically, the ISP 154 performs the image read operations 230 to access all of the received pixel data associated with the image frame, performs any required image frame reconstruction operations, and generates the processed frame data 290 associated with the image frame.

If, at step 512, the value of the discard frame 256 is true (indicating that the image frame is not to be processed by the ISP 154), then the method 500 proceeds to step 516. At step 516, the frame screener 125 orchestrates the frame drop 260. In particular, the frame screener 125 causes the ISP 154 to disregard the image frame without performing any image read operations 230 to access data associated with the image frame. As disclosed previously herein, the frame screener 125 may cause the ISP 154 to disregard the image frame in any technically feasible fashion. In some embodiments, the camera host 129 and the CPU 160 use the number of pixels stored 254 to determine the memory location in the ISP memory 140 associated with the next image frame. The CPU 160 then cause the ISP 154 to perform image read operations 230 starting at the memory location corresponding to next image frame instead of the memory location corresponding to the incomplete image frame. In operation, the ISP 154 does not perform read operations 230 associated with any image frame data that the camera host 129 stored in the ISP memory 140. In addition, as part of step 516, the camera host 129 discards all remaining pixel data included in the pixel data packets 210 without performing additional image write operations 220 to the ISP memory 140. The method 500 then terminates after step 516. Advantageously, since the ISP 154 does not perform any memory or computational operations associated with the extraneous image frame, the camera system 100 performs more efficiently and consumes less power than conventional camera systems.

In sum, the disclosed techniques enable camera systems to eliminate unproductive memory and computational operations associated with image frames that are incompletely transmitted from a camera. In one instance, for each image frame, a camera transmits one or more pixel data packets that include pixel data associated with the image frame. The camera host receives these pixel data packets and, subsequently, performs write operations on an image signal processing (ISP) memory to store pixel data. After all the pixel data packets associated with the image frame are received, a frame screener that is implemented in the camera host compares the number of pixels included in the image frame to the number of pixels for which the camera host received data. If the difference between the number of pixels included in the image frame and the number of pixels for which the camera host received data is less than a pre-configured error threshold, then the frame screener allows the ISP to process the image frame. By contrast, if the difference between the number of pixels included in each image frame and the number of pixels for which the camera host received data is not less than a pre-configured error threshold, then the frame screener configures the ISP to ignore the image frame. In particular, the frame screener ensures that the ISP ignores any pixel data associated with the image frame that the camera host wrote to the ISP memory.

Advantageously, the disclosed techniques enable the camera system to efficiently filter extraneous image data before the ISP performs operations on the image data. Notably, if a frame screener determines that the error threshold is exceeded for an image frame, then the ISP does not perform memory reads associated with the image frame and does not process any pixel data associated with the image frame. By contrast, in conventional camera systems, the ISP performs memory reads for all received pixel data and performs operations to process each image frame, irrespective of whether the ISP ultimately discards the image frame. Thus, the camera system may reduce the number of unnecessary operations associated with incompletely received image frames compared to conventional camera systems. Further, because the ISP does not perform such unnecessary operations, the rate at which the ISP processes image frames may be increased and the power consumption may be decreased.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the present invention is set forth in the claims that follow.

The invention claimed is:

1. A system configured to filter pixel data, the system comprising:
a camera; and
a frame screener coupled to the camera and configured to:
process a first packet that includes first pixel data associated with a first image frame,
determine that the first pixel data is associated with an overflow state,
compute a total number of processed pixels represented by the first pixel data and any previously processed pixel data associated with the first image frame,
determine that the total number of processed pixels is less than a minimum pixel threshold, and
configure an image signal processor to bypass one or more memory or computational operations associated with the first pixel data.

2. The system of claim 1, wherein processing the first packet comprises:
receiving the first pixel data;
determining a first memory location within a memory associated with the image signal processor based on a base memory address associated with the first image frame and a first pixel count that represents any previously stored pixel data associated with the first image frame;
performing one or more write operations to store a first subset of the first pixel data in the memory at the first memory location;
incrementing the first pixel count by the number of pixels represented by the first subset of the first pixel data.

3. The system of claim 2, wherein configuring the image signal processor comprises causing the image signal processor to bypass one or more read operations associated with the first image frame based on the base memory address and the first stored pixel count.

4. The system of claim 2, wherein the frame screener is further configured to receive a second packet that includes second pixel data associated with a second image frame, and perform one or more write operations that overwrite the first pixel data in the memory associated with the image signal processor with the second pixel data based on the base memory address.

5. The system of claim 1, where the frame screener is further configured to:
receive a second packet that includes second pixel data associated with the first image frame, and
discard the second pixel data without performing any read operations to store the second pixel data in the memory associated with the image signal processor.

6. The system of claim 1, wherein processing the first packet comprises receiving the first packet via a camera serial interface

7. The system of claim 6, wherein the camera serial interface implements a Camera Serial Interface 3 (CSI-3) protocol.

8. The system of claim 1, wherein the first pixel data is associated with a first scan line included in the first image frame, and the frame screener is further configured to disable the transmission of any subsequent packets associated with the first image frame from the camera to a camera host unit via a camera serial interface.

9. The system of claim 1, wherein the first pixel data is associated with a plurality of scan lines included in the first image frame.

10. A computer-implemented method for filtering pixel data in a camera system, the method comprising:
processing a first packet that includes first pixel data associated with a first image frame;
determining that the first pixel data is associated with an overflow state;
computing a total number of processed pixels represented by the first pixel data and any previously processed pixel data associated with the first image frame;
determining that the total number of processed pixels is less than a minimum pixel threshold; and
configuring an image signal processor to bypass one or more memory or computational operations associated with the first pixel data.

11. The method of claim 10, wherein processing the first packet comprises:
receiving the first pixel data;
determining a first memory location within a memory associated with the image signal processor based on a base memory address associated with the first image frame and a first pixel count that represents any previously stored pixel data associated with the first image frame;
performing one or more write operations to store a first subset of the first pixel data in the memory at the first memory location;
incrementing the first pixel count by the number of pixels represented by the first subset of the first pixel data.

12. The method of claim 11, wherein configuring the image signal processor comprises causing the image signal processor to bypass one or more read operations associated with the first image frame based on the base memory address and the first stored pixel count.

13. The method of claim 11, further comprising receiving a second packet that includes second pixel data associated with a second image frame, and performing one or more write operations that overwrite the first pixel data in the memory associated with the image signal processor with the second pixel data based on the base memory address.

14. The method of claim 10, further comprising:
receiving a second packet that includes second pixel data associated with the first image frame; and
discarding the second pixel data without performing any read operations to store the second pixel data in the memory associated with the image signal processor.

15. The method of claim 10, wherein processing the first packet comprises receiving the first packet via a camera serial interface

16. The method of claim 15, wherein the camera serial interface implements a Camera Serial Interface 3 (CSI-3) protocol.

17. The method of claim 10, wherein the first pixel data is associated with a first scan line included in the first image frame, and the method further comprises disabling the transmission of any subsequent packets associated with the first image frame from a camera to a camera host unit via a camera serial interface.

18. The method of claim 10, wherein the first pixel data is associated with a plurality of scan lines included in the first image frame.

19. A computing device comprising:
an image processing unit configured to process pixel data associated with a camera; and
a frame screener configured to:
process a first packet that includes first pixel data associated with a first image frame,
determine that the first pixel data is associated with an overflow state,
compute a total number of processed pixels represented by the first pixel data and any previously processed pixel data associated with the first image frame,
determine that the total number of processed pixels is less than a minimum pixel threshold, and
configure the image signal processor to bypass one or more memory or computational operations associated with the first pixel data.

20. The computing device of claim 19, wherein processing the first packet comprises
receiving the first packet via a camera serial interface.
